(19) United States
(12) Patent Application Publication
(10) Pub. No.: US 2010/0231185 A1
(43) Pub. Date: Sep. 16, 2010

(54) POWER SUPPLY DEVICE AND POWER CONVERSION ASSEMBLY THEREOF

(75) Inventors: Tung-Yao YU, Tamshui Chen (TW); Sung-Po YANG, Tamshui Chen (TW); Tzu-Ming HUANG, Tamshui Chen (TW)

Correspondence Address: PATENTTM.US, P. O. BOX 82788, PORTLAND, OR, 97282-0788, US

(73) Assignee: ACBEL POLYTECH INC., Tamshui Chen (TW)

(21) Appl. No.: 12/634,778

(22) Filed: Dec. 10, 2009

(30) Foreign Application Priority Data
Mar. 11, 2009 (TW) 098203714

(51) Int. Cl. G05F 1/10

(52) U.S. Cl. 323/282

(57) ABSTRACT

A power conversion assembly includes a conversion box, a conversion lead and a plurality of adapter plugs. The conversion box has a power regulation circuit, a variable switch, a power input port, a power output port and at least a interface port. The variable switch, the power input port, the power output port and the at least one interface port are connected with the power regulation circuit. When the conversion box is connected with the power adapter to obtain a DC power, a DC power with a different voltage can be sent out by the switching of the variable switch and the regulation of the power regulation circuit. One end of the conversion lead is used to receive the regulated DC power from the conversion box. The other end of the conversion lead can be replaced with the adapter plug having different specification to supply power to different power-requiring equipment.

### BACKGROUND OF THE INVENTION

1. Field of the Invention

The present invention relates to a power conversion assembly, and more particularly to a power conversion assembly, which converts output power to customized DC power of different specifications by incorporating a power adapter and a switching adjustment so as to supply customized DC power.

2. Description of Related Art

Most portable electronic appliances adopt a rechargeable battery to supply a DC operating power. Beyond that, external power supply can also be used to supply power and charge a rechargeable battery. With reference to FIG. 8, a conventional power adapter (80) has an AC power cable (81) and a DC power cable (82) mounted thereon. The AC power is acquired through the AC power cable (81) by inserting the plug in an AC mains outlet. The AC power is rectified and a voltage dropped by an internal circuit of the power adapter (80) and DC power is supplied through the DC power cable (82). A connector (83) having a specific specification and mounted on the other end of the DC power cable (82) serves to connect with electronic equipment requiring power.

The aforementioned conventional power adapter (80) has becomes commonplace in daily life. However, cases of incurring inconvenience and failing to meet economic effect take place from time to time. The reason mainly lies in that the electronic appliances developed and marketed by all leading manufacturers employ inconsistent power specification. As a result, as far as voltage specification and connector type is concerned, power adapters are not all the same. Such cases are normally found in electronic appliances such as notebook computer, mobile phone and so forth. Given the notebook computer as an example, the power specifications required by each branded notebook computer may be diverse, such as, 15V, 16V, 17V, 18V, 19V, 20V, and so forth, meaning that a duplicated waste of resources arises from incompatible power adapters and connectors dedicated to different notebook computers.

Moreover, as each conventional power adapter (80) is dedicated to specific equipment, it can do nothing but generating DC power with a specific specification to a specific power need. In fact, DC power use varies considerably. If different power adapters need to be purchased for different uses, resources are wasted. Besides, possession of all kinds of power adapters creates storage and operation problems. In view of the foregoing concerns, conventional power adapters waste resources and are inconvenient. Therefore, a feasible solution needs to be addressed.

### SUMMARY OF THE INVENTION

The main objective of the present invention is to provide a power conversion assembly in collaboration with the use of a power adapter. The power conversion assembly regulates a DC power outputted from an original power adapter to various power sources with different specifications by switching the DC power based on users' demand. The power conversion assembly also provides multiple sets of adapter plugs to suit different power-requiring equipment. Existing resources can be fully utilized to facilitate the use of power.

To achieve the aforementioned main objective, a power conversion assembly has a conversion box, a conversion lead and a plurality of adapter plugs.

The conversion box has a power regulation circuit and a variable switch. The variable switch has multiple switch contacts and a common end, a power input port, a power output port and at least one interface port mounted thereon and connected with the power regulation circuit.

The power regulation circuit has a DC to DC conversion unit, a feedback regulation unit and a buck conversion unit.

The DC to DC conversion unit is mounted between the power input port and the power output port.

The feedback regulation unit is electronically connected to the variable switch and mounted between the DC to DC conversion unit and the power output port to regulate an output voltage of the DC to DC conversion unit.

The buck conversion unit is mounted between the power input port and the interface port.

The conversion lead has two ends, one of which is connected to the power output port.

Each of the plural adapter plugs with different specification is connected to the other end of the conversion lead.

The power conversion assembly can be used in collaboration with an existing power adapter. Most importantly is that the power output end of the power adapter is connected with the power input port on the conversion box, and the conversion lead is connected with the power output port on the conversion box. Therefore, users can switch the variable switch to select the DC power source with the desired specification based on their demand and select a matching adapter plug which is mounted on the other end of the conversion lead for the connection with power-requiring equipment. Accordingly, the power regulation circuit inside the conversion box converts the DC power sent out from the power input port and regulates it to the DC power with the configured specification in accordance with the setup of the variable switch and transmits the DC power to the power-requiring equipment through the power output port, the conversion lead and the adapter plug. Besides, the conversion box provides at least one interface port for the power-requiring equipment to be connected with the interface port by virtue of an interface connector, so as to acquire a DC working power.

The power conversion assembly of the present invention can convert the outputted DC power with specific specification into a customized DC power, so relieving storage and use issues associated with ownership of multiple power conversion assemblies. Moreover, a technical means for supplying power through an interface port makes the use of power more flexible.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first preferred embodiment of a power supply device and power conversion assembly in accordance with the present invention;

FIG. 2 is an exploded perspective view of a conversion lead in the first preferred embodiment of the present invention;

FIG. 3 is a circuit diagram of the power supply device and power conversion assembly in accordance with the present invention;

FIG. 4 is a an exploded perspective view of the power supply device and power conversion assembly connected to a power adapter in the first preferred embodiment of the present invention;

FIG. 5 is a schematic view of a second preferred embodiment of a power supply device and power conversion assembly in accordance with the present invention;

FIG. 6 is an exploded perspective view of another feasible solution of the second preferred embodiment in collaboration with the use of a power adapter;

FIG. 7 is a perspective view of a third preferred embodiment of a power supply device and power conversion assembly in accordance with the present invention; and

FIG. 8 is a perspective view of a conventional power adapter.

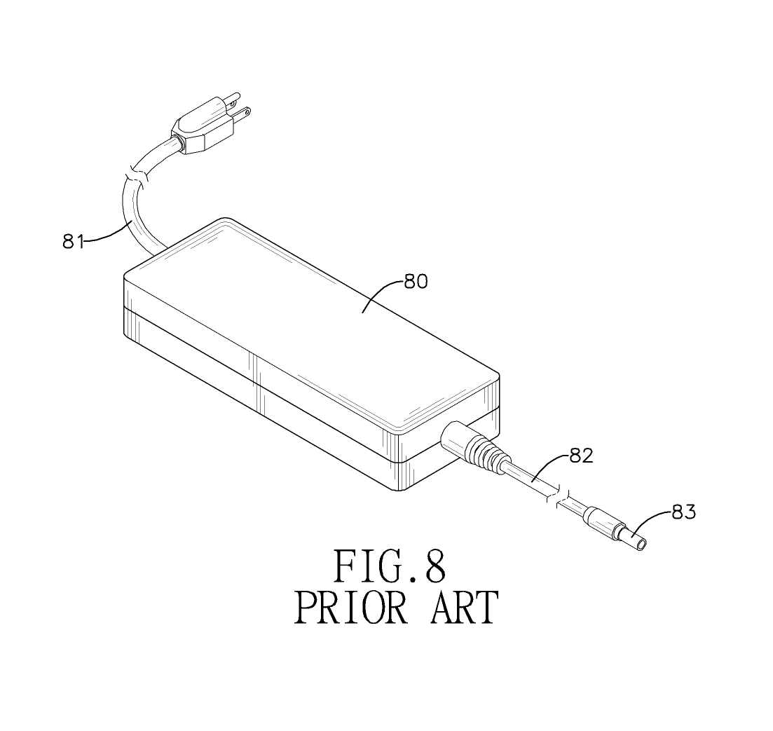

### DETAILED DESCRIPTION OF THE PREFERRED EMBODIMENT

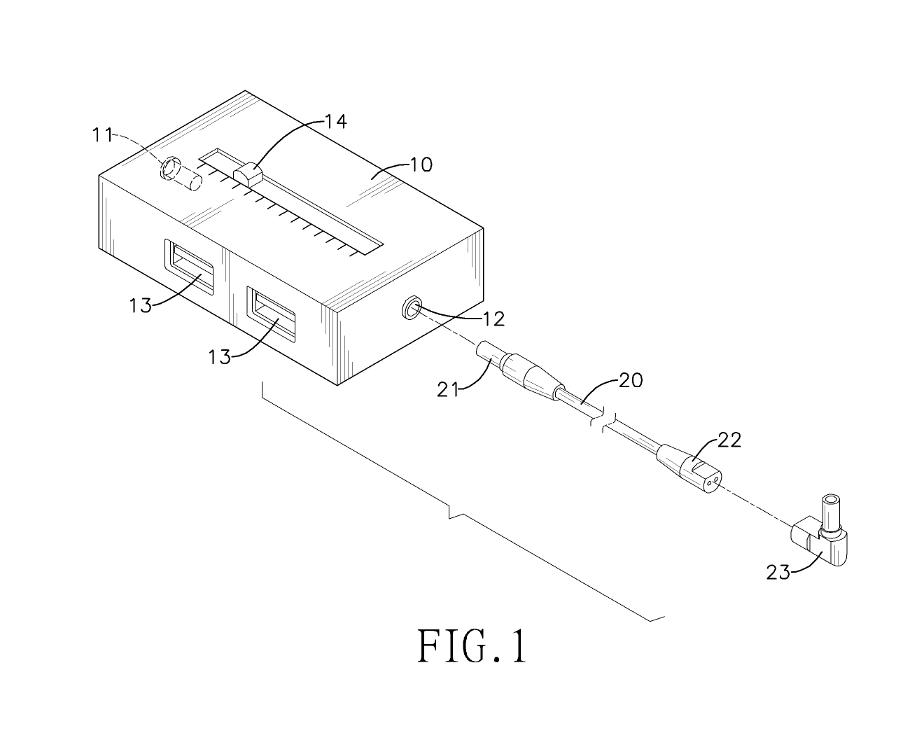

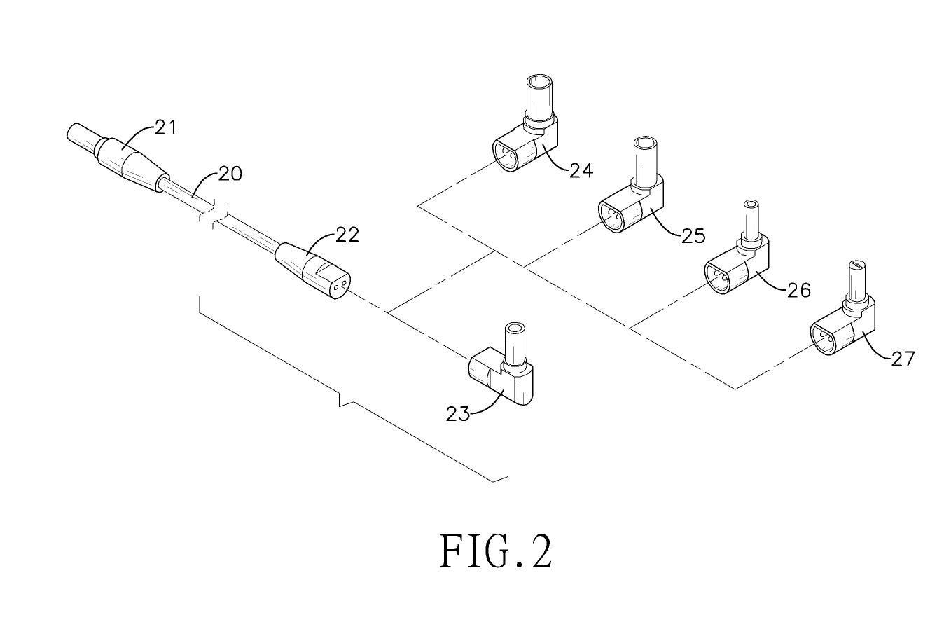

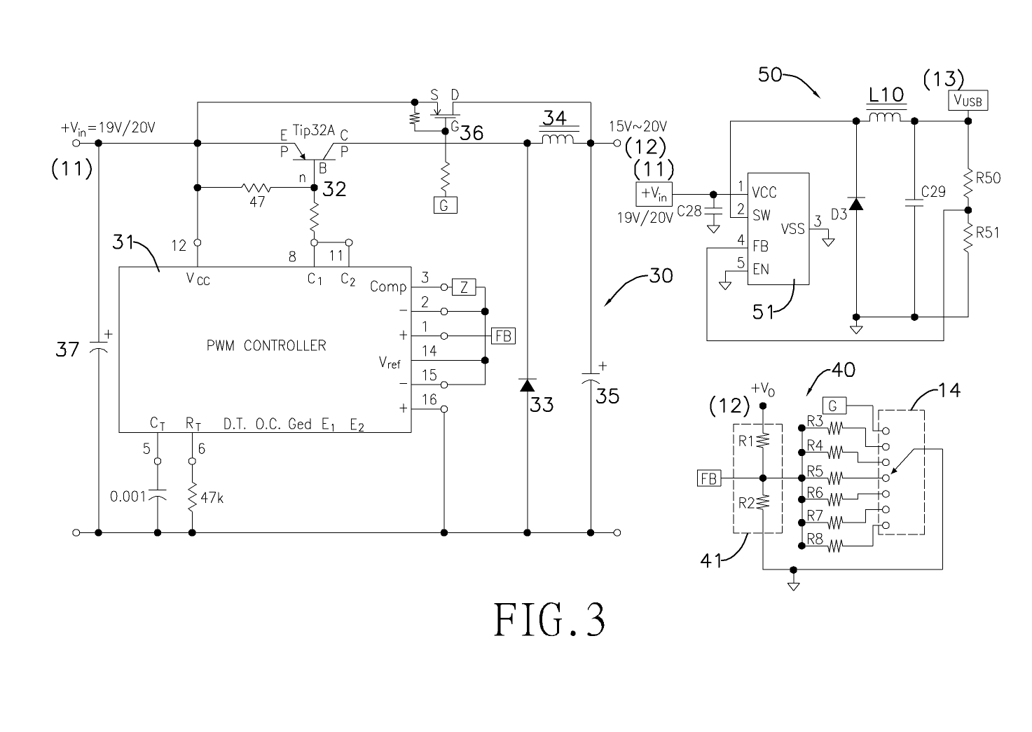

With reference to FIGS. 1 and 3, a conversion assembly in accordance with a first embodiment of the present invention has a conversion box (10), a conversion lead (20) and a plurality of adapter plugs (23). The conversion box (10) has a variable switch (14) having multiple switch contacts, a common end, a power input port (11), a power output port (12) and at least one interface port (13), and a power regulation circuit (not shown). The power input port (11) is connected with a power output end of a power adapter. The power output port (12) is detachably connected with a conversion lead (20). One end of the conversion lead (20) has a plug (21) complying with the power output port (12). The other end of the conversion lead (20) has a connector (22), which is coupled with an adapter plug (23) and electrically connected therewith. With further reference to FIG. 2, the connector (22) of the conversion lead (20) can be connected to adapter plugs (24)˜(27) with different specification in a replaceable manner. One end of each adapter plug (23)˜(27) matches with the connector (22) and can be coupled therewith in generation of an electrical connection. The other end of each adapter plug (23)˜(27) is provided with an equipment plug having unique specification for connection to respective power-requiring equipment. In the present embodiment, the conversion box (10) has two interface ports (13) thereon. The interface ports (13) are compatible with a USB interface and have a set of power terminals, which enable supply of 5V DC power to a power-requiring equipment connected with compatible interface through a connector.

The power regulation circuit of the conversion box (10) is connected with the power input port (11), the power output port (12), the interface ports (13) and the variable switch (14) respectively.

With reference to FIG. 3, the power regulation circuit has a DC to DC conversion unit (30), a feedback regulation unit (40) and a buck conversion unit (50).

The DC to DC conversion unit (30) has a pulse width modulation (PWM) controller (31), an electronic switch (32), an input capacitor (37), a freewheel diode (33), an output inductor (34), an output capacitor (35) and a bypass switch (36). The electronic switch (32) is connected between the power input port (11) and the power output port (12) and is controlled to be on or off by the PWM controller (31). The electronic switch (32) is specifically a PNP transistor. The emitter and the collector of the transistor are connected with the power input port (11) and the power output port (12) respectively. The base is connected with an output end of a PWM controller (31) to facilitate the control of the PWM controller (31) over the power voltage to the power output port (12) via the electronic switch (32). The PWM controller (31) has a non-inverting input terminal (FB) (Pin 1). When the potential of the non-inverting input terminal (FB) varies, the PWM controller (31) is enabled to change the pulse width of the driving signal and consequentially adjust the power voltage sent to the power output port (12). To one ordinarily skilled in the related field, when the selected IC model is different, the output voltage can be regulated by varying the potential of its inverting input terminal.

Furthermore, the bypass switch (36) is connected between the power input port (11) and the power output port (12) and is controlled to be on or off by one of the switch contacts of the variable switch (14). When the bypass switch (36) is on, the DC power sent to the power input port (11) is directly supplied to the power output port (12). For example, when the input DC power is 20V, the power output port (12) is enabled to directly output 20V DC power by the bypass means to prevent the low conversion efficiency issue that converts 20V input voltage to 20V DC power without exception. In the present embodiment, the bypass switch (36) is composed of a P-MOSFET whose source and drain are connected with the power input port (11) and the power output port (12) respectively, and gate is connected with the variable switch (14).

In the present embodiment, the DC to DC conversion unit (30) constitutes a buck converter in collaboration with the freewheel diode (33), the output inductor (34) and the output capacitor (35). Other than that, it can be a boost converter and a buck-boost converter as well.

The feedback regulation unit (40) is connected between the power output port (12) and the DC to DC conversion unit (30). The feedback regulation unit (40) has a voltage division circuit (41) and a plurality of regulating resistors R3˜R8. The voltage division circuit (41) has a resistor R1 and a resistor R2 connected to the resistor R1 in series. A voltage division node of R1 and R2 is connected with the non-inverting input terminal (FB) of the PWM controller (31). The other end of R1 is connected with the power output port (12). The resistance values of the regulating resistors R3˜R8 are all different; one end of the regulating resistors is connected with the voltage division node of the voltage division circuit (41), and the other end is connected with the corresponding switch contact of the variable switch (14). When the common end of the variable switch (14), which is a ground, is connected with the regulating resistors R3˜R8 on the different switch contacts, different voltage division impedance values are generated by the voltage division circuit (41). Different potentials are generated on the voltage division node and fed back to the non-inverting input terminal (FB) of the PWM controller (31) of the DC to DC conversion unit (30). The output voltage of the DC to DC conversion unit (30) varies according to the voltage division equation V_{O}=V_{ref} (1+R1/R2′), where R2′ is generated by connecting R2 in parallel with R3 to R8. Therefore, users can select a DC power with a desired voltage (e.g. when the output DC power is 19V, it can be selectively switched to 18˜15V through the variable switch (14). In addition, the variable switch (14) is connected with the gate of the bypass switch (36) by a switch contact G thereof When users switch to the section, the gate of the bypass switch (36) is on, the inputted 19V DC power is directly outputted to the power output port (12) to avoid low conversion efficiency.

A buck conversion unit (50) is mounted between the power input port (11) and the interface port (13). The buck conversion unit (50) is a PWM DC to DC converter (51), a freewheel diode D3, an output inductor L10 and an output capacitor C29. Generally, the DC power, which is supplied to the power input port (11), is a relatively high voltage (e.g. 20V, 19V, etc.). The buck conversion unit (50) coverts the DC power with high voltage and then outputs a DC power with low voltage (e.g. 5V) to the interface port (13) to comply with a power specification of the interface port (13). As mentioned earlier, the interface port (13) is a USB port and has a set of power terminals (V+, V−) thereon for supplying a 5V DC power. When a power-requiring equipment is plugged in the interface port (13) on the conversion box (10) through a USB connector, the power-requiring equipment can simply acquire the 5V DC power through the interface port (13).

The aforementioned description sheds light on the external structure, the internal circuit structure and the working theory of a preferred embodiment in accordance with the present invention. As to its operation, the details are described as follows:

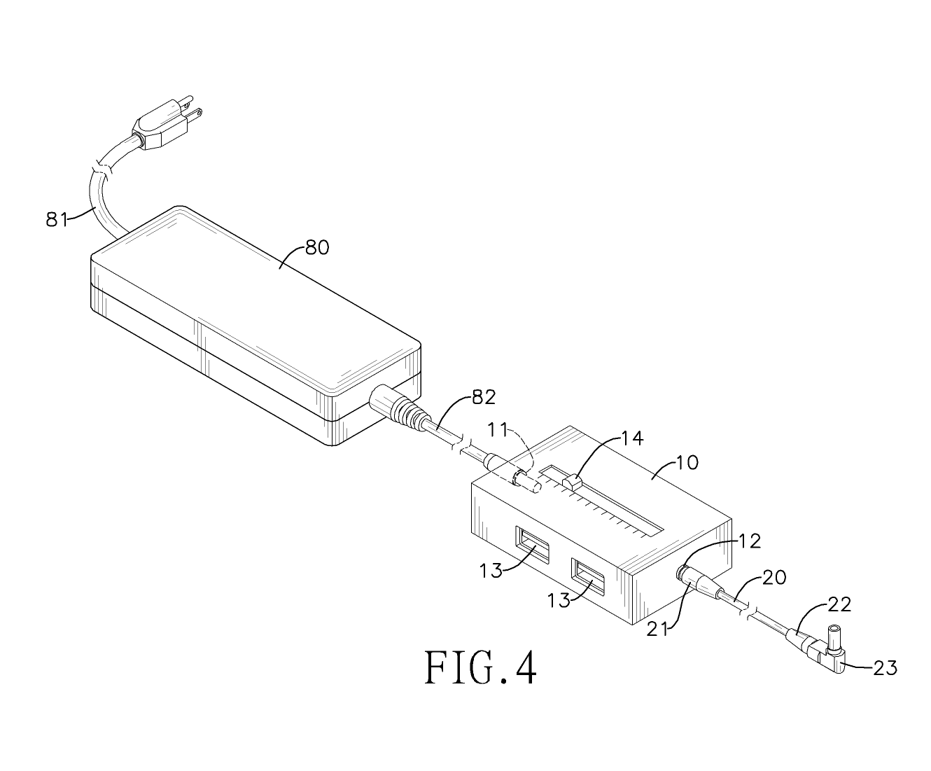

With reference to FIG. 4, the aforementioned power conversion assembly is preferably used in collaboration with the existing power adapter. This means that users can take advantage of the aforementioned power conversion assembly and incorporate the original power adapter (80) to obtain a power with different specification so as to adapt it to the need of different power-requiring equipment. A DC power cable (82) of the power adapter (80) is plugged in the power input port (11) on the conversion box (10). The plug on one end of the conversion lead (20) is plugged in the power output port (12) on the conversion box (10). Subsequently, an adapter plug (23) matching with an electrical connector of the power-requiring equipment is selected and coupled with the connector (22) on the other end of the conversion lead (20) to facilitate the connection of the adapter plug (23) with the power-requiring equipment. On the other hand, users can select the DC power of desired specification by switching the variable switch (14) as requested. The power regulation circuit inside the conversion box (10) then regulates the DC power sent out from the power input port into the specified DC power chosen by the variable switch (14). The DC power is further transmitted to the power-requiring equipment through the power output port (12), the conversion lead (20) and the adapter plug (23). Because voltages and adapter plugs with various specifications are available, consumers can fully explore the use of the original power adapter to satisfy different requirement of DC power on different occasions.

So far, a lot of small electric appliances in the market adopt USB connectors as the power acquisition interface. However, the conversion box (10) of the present invention provides the interface port (13) for supplying power, thereby providing another choice in power acquisition while consumer operates those small electric appliances.

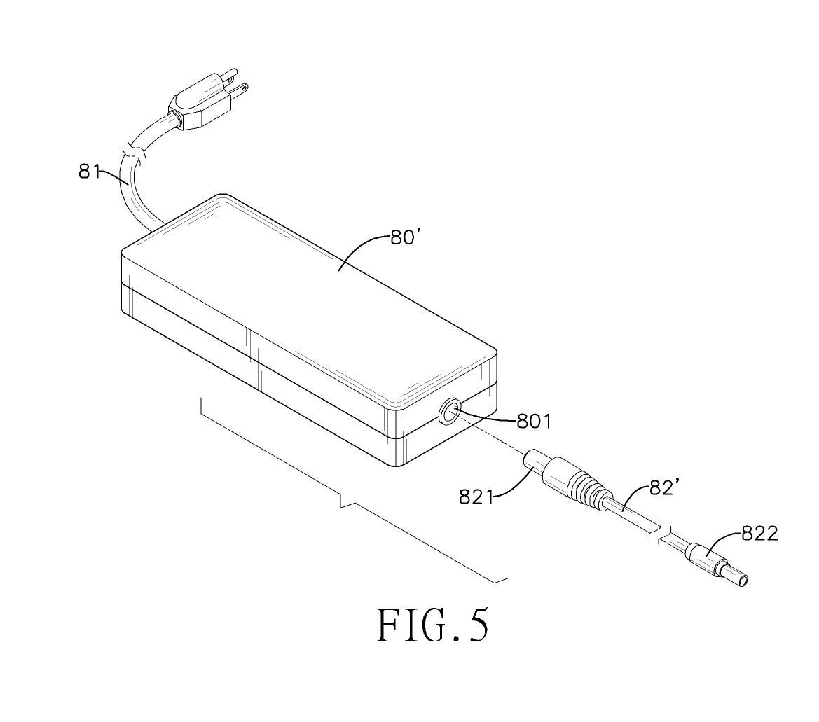

Furthermore, the power adapter (80) is used in cooperation with the aforementioned power conversion assembly. Its DC power cable (82) can be fixedly and detachably connected with the power adapter (80). With further reference to FIG. 5, a second embodiment of a power adapter (80′) has a power output port (801) thereon for the connection with a DC power cable (82′). One end of the DC power cable (82′) has a plug (821) matching with the power input port (801). The other end of the DC power cable (82′) has a connector (822) matching with the power input port (11) on the conversion box (10). Accordingly, the DC power cable (82′) can also be assembled or disassembled with the power adapter (80′) as needed.

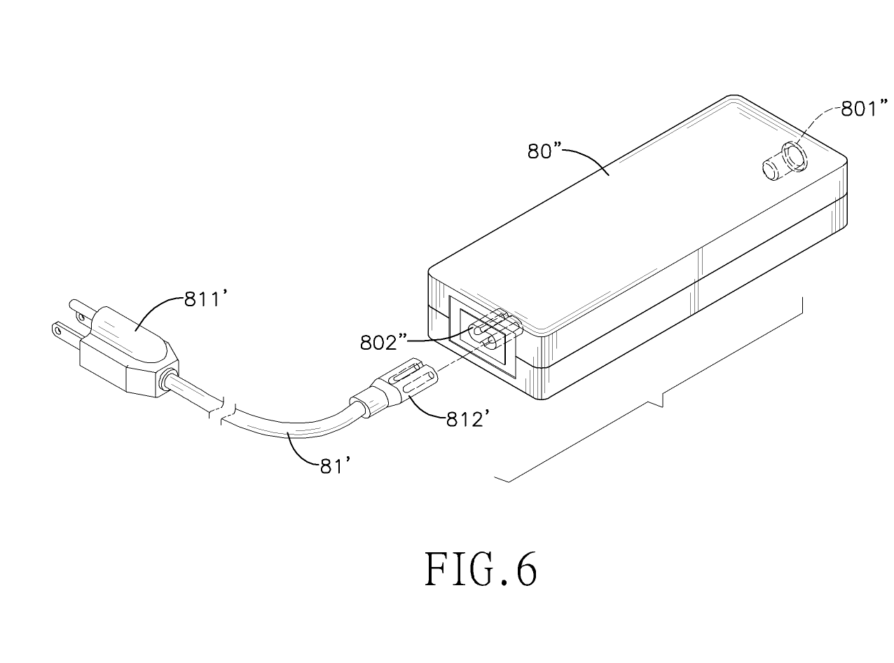

In addition to the DC power cable (82′), the detachable design can be adopted to the AC power cable in a similar fashion. With reference to FIG. 6, a third embodiment of a power adapter (80″) has a power input port (802″) and a power output port (801″) thereon. In the present embodiment, the power input port (802″) is an AC power outlet and provides an AC power cable (81′) to detachably connect with the power input port (802″). Based on the aforementioned demand, one end of the AC power cable (81′) has an AC mains plug (811′) for power acquisition by plugging it in an AC mains outlet. The other end has an adapter plug (812′) matching with the power input port (802″) on the power adapter (80″), so that the power adapter (80″) and the AC power cable (81′) can be mutually connected in a detachable manner

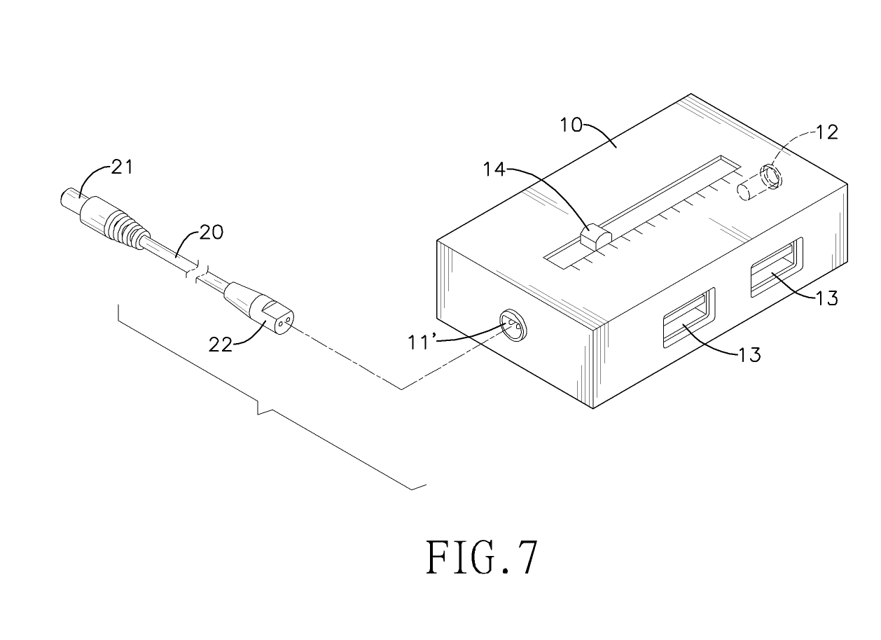

With reference to FIG. 7, in a third preferred embodiment of the present invention, the structure of the conversion box (10) is similar to that of the previous embodiment. The distinction therebetween lies in that the power input port (11′) matches with the connector (22) of the aforementioned conversion lead (20). In other words, the power input port (11′) and the power output port (12) of the conversion box (10) can employ the conversion lead (20) with identical form to be respectively connected with the power output port (801)(801″) of the power adapter and the adapter plugs (23)˜(27). This makes the lead even more simple in selection and convenient in operation.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A power conversion assembly, comprising:
a conversion box having a power regulation circuit therein and further having a variable switch having multiple switch contacts and a common end, a power input port, a power output port and at least one interface port mounted thereon and connected with the power regulation circuit, wherein the power regulation circuit comprises:
a DC to DC conversion unit mounted between the power input port and the power output port;
a feedback regulation unit electronically connected to the variable switch and mounted between the DC to DC conversion unit and the power output port to regulate an output voltage of the DC to DC conversion unit; and
a buck conversion unit mounted between the power input port and the interface port;
a conversion lead having two ends, one of which is connected to the power output port; and
a plurality of adapter plugs with different specification and each of which is connected to the other end of the conversion lead.

2. The power conversion assembly as claimed in claim 1, wherein the DC to DC conversion unit comprises:
a PWM controller having an input terminal;
an electronic switch connected between the power input port and the power output port and controlled to on or off by the PWM controller; and
a bypass switch connected between the power input port and the power output port and controlled to be on or off by one of the switch contacts of the variable switch.

3. The power conversion assembly as claimed in claim 2, wherein
the common end of the variable switch is a ground; and
the feedback regulation unit comprises:
a voltage division circuit has a first resistor, a second resistor connected to the first resistor in serial and a voltage division node connected to the input terminal of the PWM controller;
a plurality of regulating resistors each of which has a different resistance value, one end thereof is connected with the voltage division node of the voltage division circuit and the other end thereof is connected with corresponding switch contact of the variable switch.

4. The power conversion assembly as claimed in claim 3, wherein the bypass switch of the DC to DC conversion unit is a P-MOSFET having a source, a drain and a gate, wherein the source and the drain of the P-MOSFET are connected with the power input port and the power output port respectively, and the gate is connected to one of the switch contacts of the variable switch.

5. The power conversion assembly as claimed in claim 3, wherein the electronic switch is a transistor having a emitter, collector and a base, wherein the emitter and the collector of the transistor are connected to the power input port and the power output port respectively, and the base is connected to an output end of the PWM controller.

6. The power conversion assembly as claimed in claim 1, wherein the DC to DC conversion unit is a buck converter, a boost converter or a buck-boost converter.

7. The power conversion assembly as claimed in claim 2, wherein the buck conversion unit is a buck conversion circuit having a PWM DC to DC converter.

8. The power conversion assembly as claimed in claim 1, wherein the interface port is a USB port having a set of power terminals.

9. A power supply device with a power conversion assembly as claimed in claim 1, comprising:
a power adapter having an AC power cable and a DC power cable;
the power conversion assembly connected with the DC power cable of the power adapter.

10. The power supply device with a power conversion assembly as claimed in claim 9, wherein the DC to DC conversion unit comprises:
a PWM controller having an input terminal;
an electronic switch connected between the power input port and the power output port and controlled to on or off by the PWM controller; and
a bypass switch connected between the power input port and the power output port and controlled to be on or off by one of the switch contacts of the variable switch.

11. The power supply device as claimed in claim 10, wherein
the common end of the variable switch is a ground; and
the feedback regulation unit comprises:
a voltage division circuit has a first resistor, a second resistor connected to the first resistor in serial and a voltage division node connected to the input terminal of the PWM controller;
a plurality of regulating resistors each of which has a different resistance value, one end thereof is connected with the voltage division node of the voltage division circuit and the other end thereof is connected with corresponding switch contact of the variable switch.

12. The power supply device as claimed in claim 11, wherein the bypass switch of the DC to DC conversion unit is a P-MOSFET having a source, a drain and a gate, wherein the source and the drain of the P-MOSFET are connected with the power input port and the power output port respectively, and the gate is connected to one of the switch contacts of the variable switch.

13. The power supply device as claimed in claim 11, wherein the electronic switch is a transistor having a emitter, collector and a base, wherein the emitter and the collector of the transistor are connected to the power input port and the power output port respectively, and the base is connected to an output end of the PWM controller.

14. The power supply device as claimed in claim 9, wherein the DC to DC conversion unit is a buck converter, a boost converter or a buck-boost converter.

15. The power supply device as claimed in claim 10, wherein the buck conversion unit is a buck conversion circuit having a PWM DC to DC converter.

16. The power supply device as claimed in claim 9, wherein the interface port is a USB port having a set of power terminals.
